(19) United States
(12) Patent Application Publication
(10) Pub. No.: US 2022/0309090 A1
(43) Pub. Date: Sep. 29, 2022

(54) SYSTEMS AND METHODS FOR MODIFYING QUANTIFIED MOTIVATIONAL IMPACT BASED ON AUDIO COMPOSITION AND CONTINUOUS USER DEVICE FEEDBACK

(71) Applicant: Switchfly AI, LLC, Los Angeles, CA (US)

(72) Inventors: Ryan Wenger, Pacific Palisades, CA (US); Ilya Povidalo, Dubna (RU)

(21) Appl. No.: 17/209,255

(22) Filed: Mar. 23, 2021

(51) Int. Cl. G06F 16/435; G06F 16/438; A63B 24/00

(52) U.S. Cl. CPC G06F 16/436; G06F 16/438; A63B 24/0062

(57) ABSTRACT

A system and method for generating an ordered list of content objects, are disclosed. The system is configured to receive content objects from one or more datastores and generate attributes for each content object. Further, weighted scores are computed for each attribute, such that a sum of all computed weighted scores is indicative of a suitability of association of the content object with a feature set execution. A master lookup dataset is generated comprising the content object, computed weighted scores, and a mapping between the content object and the feature set execution. Content objects prestored on user device are identified and an ordered list is created by associating content objects to feature sets based on the master lookup dataset.

### CROSS-REFERENCE TO RELATED APPLICATIONS

None.

### BACKGROUND OF THE INVENTION

### Field of the Art

The disclosure relates to the field of identification, categorization, and ordering of content objects based on user device interaction with one or more feature sets.

### Discussion of the State of the Art

Conventionally, music has been an integral part of workouts for people when exercising individually or within a group, such as in a gym. It is well known that music has positive effects on workout performance. For example, music may positively influence users' endurance, performance, and intensity during a workout regime. Further, music may boost the temperaments of users during exercising and raise their confidence to reach certain predetermined goals.

In particular, since the turn of the 21^{st} century, the use of portable media devices and biometric sensors in exercises, especially during walking, running, or jogging outdoors, has increased. These portable media devices further allow the users to, for example, create workout specific music playlists to help them stick to their workout regimes and move towards their fitness goals. For instance, a runner may create a playlist containing one or more music tracks they believe drive them to run better by means of their lyrical content and/or tempo. Some of these systems known in the art attempt to play an appropriate song at the appropriate time, but none of them are sufficient. That is, a user often decides to utilize a preconfigured list of music from a streaming service or to compile their own selection, however a preconfigured list is not responsive to different intensity levels or continuous changes of a workout.

Most recently, several mobile apps—like Fit Radio™, Spring™, and RockMyRun™ have implemented a system where a musical composition is matched to a user's heartrate or speed. However, these apps fall short for two primary reasons. First, they only consider one of many variables in a song—the BPM. While tempo is an important factor, there are numerous other elements such as lyrics, popularity, instruments, valence, and the like, that can be used for analysis, but are not. One of the most popular selected songs by users, for example, is “We Are the Champions” by Queen™ for its motivational effects on exercise; but since it has a low BPM of 92, it would never be selected by systems known in the art that rely primarily on a simplistic BPM sorting (i.e. a BPM of 92 would typically be considered too low for motivation).

Second, music is profoundly personal. Due to differences in gender, age, region and above all else individual experience associated to specific musical compositions, the traits that make a song highly motivating for one user, may not for another. Since systems known in the art do not model how people react to a particular musical composition, they cannot personalize a selection. As a result of these two disadvantages, these apps do not select songs that consistently resonate with their listeners nor provide an increase in motivation.

What is needed in the art are systems and methods for generating an ordered list of content objects, categorized based on user device selection of one or more feature sets, wherein the ordered list of content objects are updated based on feedback received from one or more user devices during interaction of the user devices with the feature sets to achieve a performance gain.

What is further needed in the art are systems and methods for analyzing a variety of song attributes to compute its motivational impact and analyze feedback from the user while in use, to personalize an arrangement for modifying a motivational impact specific to the user, whereby a selection of a most impactful songs at the most appropriate time are selected by machine learning techniques thereby improving over time.

### SUMMARY OF THE INVENTION

Accordingly, the inventor has conceived and reduced to practice, in a preferred embodiment of the invention, a system and method to generate an ordered list of content objects based on categorization of the content objects using a quantified motivational impact factor and continuous user feedback from a plurality of user devices.

Methods and systems for creating personalized and adaptive content object lists for users are disclosed. The system predicts a motivational impact factor for one or more content objects and categorize them into one of an array of groups divided by their appropriateness for different intensity levels of a feature set. Further, a content object is provided from the categorized list, based on a measurement of the user's physical intensity level. Finally, user device response to the content object including biometric and behavioral responses are used to create personalized predictions for the user device.

According to a preferred embodiment of the invention, a system for generating an ordered list of content objects comprises a network-connected content object computer comprising a memory, a processor, and a plurality of programming instructions, the plurality of programming instructions when executed by the processor cause the processor to: receive a first plurality of content objects from one or more datastores over a network; generate a plurality of attributes for each content object of the first plurality of content objects; compute weighted scores for each of the plurality of attributes, wherein a sum of all computed weighted scores for a content object is indicative of a suitability of association of the content object with a feature set execution; generate a master lookup dataset comprising temporal relationships between the content object, a sum of computed weighted scores for the content object, and a mapping between the content object and a feature set execution; identify a second plurality of content objects stored in a memory of the user device; determine one or more feature sets associated with the user device; create an ordered list of the second plurality of content objects by associating each content object from the second plurality of content objects with at least one of the one or more feature sets based on the master lookup dataset; and send the ordered list of the second plurality of content objects to the user device.

According to another preferred embodiment of the invention, the programming instructions, when further executed by the processor cause the processor to compute the weighted scores for each of the plurality of attributes based on third-party data associated with each of the plurality of attributes.

According to another preferred embodiment of the invention, the programming instructions, when further executed by the processor cause the processor to receive a feature set selection from the user device; determine whether the user device is interacting with the selected feature set; in response to a determination that the user device is interacting with a selected feature set, collect biometric data from user device; and provide a content object for playback on the user device, from the ordered list of second plurality of content objects, based at least on the collected biometric data.

According to another preferred embodiment of the invention, the programming instructions, when further executed by the processor cause the processor to: determine if a pre-generated list of content objects is stored in the memory of the user device; in response to a determination that the pre-generated list of content objects is stored in the memory of the user device, determine a value of intensity level associated with the selected feature set; and select a content object for playback on the user device, based on the determined value of intensity level.

According to another preferred embodiment of the invention, the programming instructions, when further executed by the processor cause the processor to identify, for the selected feature set, an intensity level range associated with the selected feature set; determine a user biometric compatible with the user device; compute, for the intensity level range, a plurality of threshold values comprising a high intensity threshold, a low-mid intensity threshold, and high-mid intensity threshold for the compatible user biometric; and provide a content object for playback on the user device, from the ordered list of second plurality of content objects, based on a comparison of the collected biometric data with the plurality of threshold values.

According to another preferred embodiment of the invention, the programming instructions, when further executed by the processor cause the processor to determine if a pre-generated list of content objects is stored in the memory of the user device; and in response to a determination that the list of pre-generated list of content objects is not stored in the memory of the user device, select a content object from the master lookup dataset for playback on the user device.

According to another preferred embodiment of the invention, the programming instructions, when further executed by the processor cause the processor to receive a feature set selection from the user device; identify an intensity level range for the selected feature set; for each intensity level in the intensity level range, select one or more content objects from the ordered list of second plurality of content objects; randomize an order of the selected one or more content objects; create an ordered list of the selected one or more content objects; and associated the ordered list of the selected one or more content objects with the selected feature set.

According to another preferred embodiment of the invention, the programming instructions, when further executed by the processor cause the processor to start playback of a content object, from the ordered list of the second plurality of content objects, on the user device; receive biometric data from the user device; determine whether historic data stored for the user device contains more than one content object for a given period of time; in response to a determination that the historic data for the user device contains more than one content object for a particular period of time, compare the biometric data received from user device to threshold data for the particular period of time; and switch the playback to another content object from the ordered list of the second plurality of content objects on the user device, based on the comparison.

According to another preferred embodiment of the invention, the programming instructions, when further executed by the processor cause the processor to determine, in response to switching playback to another content object, whether a user device action is received from the user device; if a user device action is received, identify the type of user device action; and modify the playback based on the identified type of user device action.

According to another preferred embodiment of the invention, the identified type of user device action is a termination request, wherein the programming instructions, when further executed by the processor cause the processor to terminate playback of a content object currently played on the user device and record statistical data associated with the user device; and present the statistical data for display on the user device.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary content object computer for categorization and dynamic ordering of content objects based on classifications and user biometric data, according to a preferred embodiment of the invention.

FIGS. 6A-B illustrate an exemplary method for categorization of a plurality of content objects based on a plurality of user device inputs combined with user biometric data, according to an embodiment of the invention.

FIG. 7A-B illustrate an exemplary method for generating an ordered listing of content objects based on device engagement with a feature set, according to an embodiment of the invention.

FIGS. 8A-C illustrate an exemplary method for creating a multilayer perceptron (MLP) classifier, according to an embodiment of the invention.

FIG. 9 illustrates an exemplary method to retrain a multilayer perceptron (MLP) classifier, according to an embodiment of the invention.

FIG. 10 illustrates an exemplary method for associating a dynamic ordered listing of content objects with a selected feature set, according to an embodiment of the invention.

### DETAILED DESCRIPTION

The inventor has conceived, and reduced to practice, a system and method to create an ordered list of a plurality of content objects that is created based on interaction of user devices with selected feature sets, and dynamically updated in response to change in intensity levels of said feature sets during said interaction.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and to more fully illustrate one or more aspects of the inventions. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

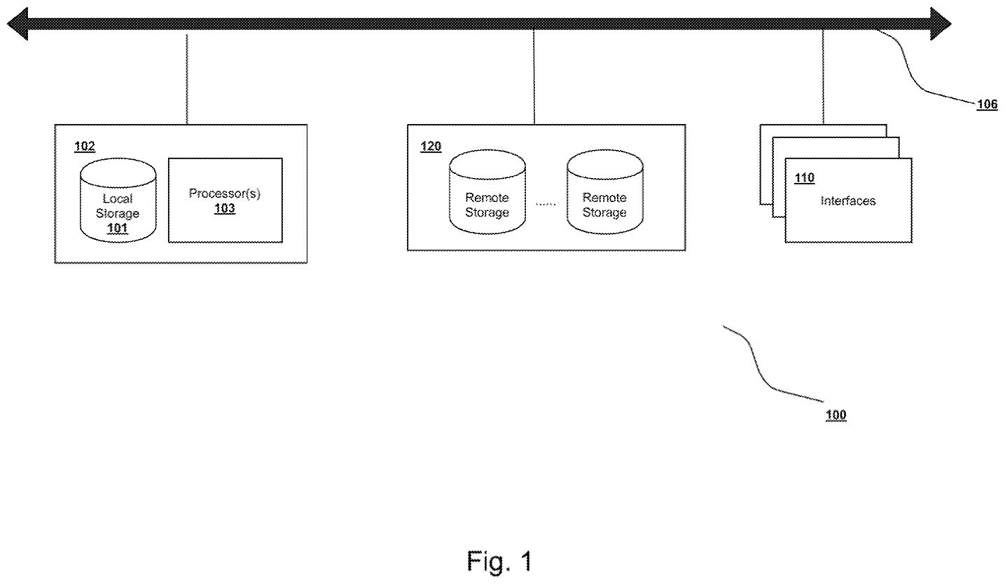

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

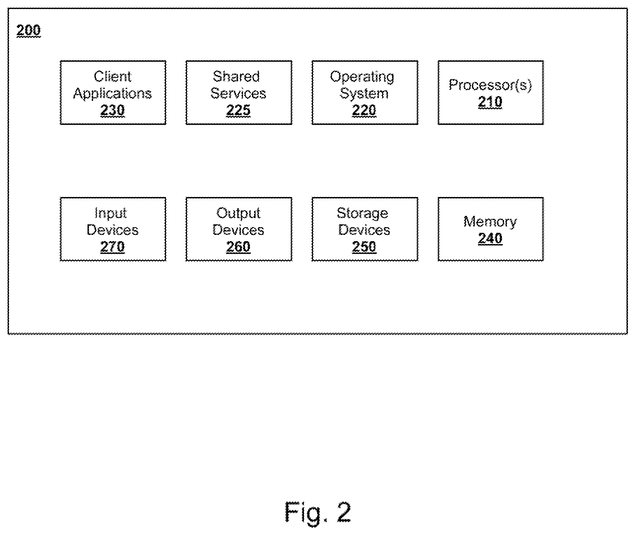

In some embodiments, systems according to the present invention may be implemented on a standalone computing system. Referring now to FIG. 2, a block diagram depicting a typical exemplary architecture of one or more embodiments or components thereof on a standalone computing system is shown. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200 and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

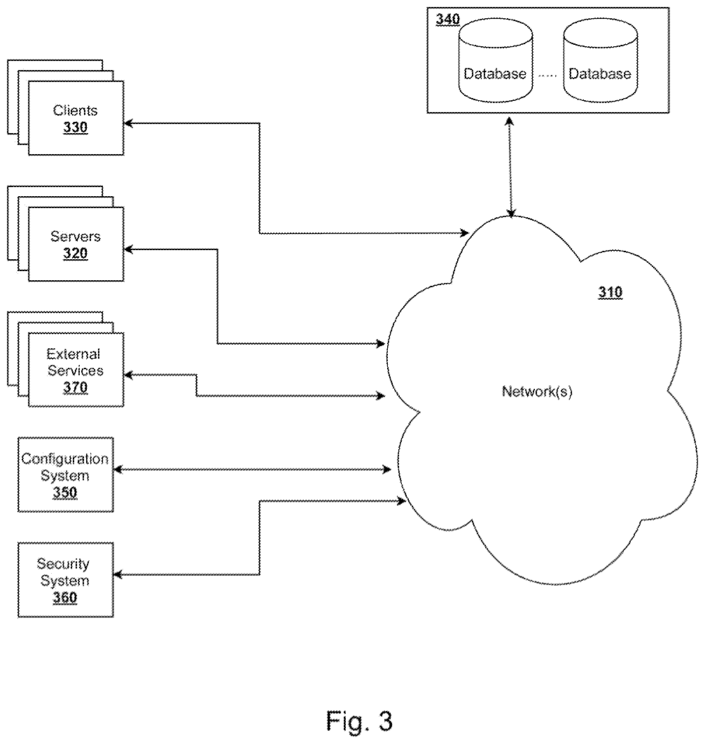

In some embodiments, systems of the present invention may be implemented on a distributed computing network, such as one having any number of clients and/or servers. Referring now to FIG. 3, a block diagram depicting an exemplary architecture 300 for implementing at least a portion of a system according to an embodiment of the invention on a distributed computing network is shown. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to receive additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may receive information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google Bigtable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

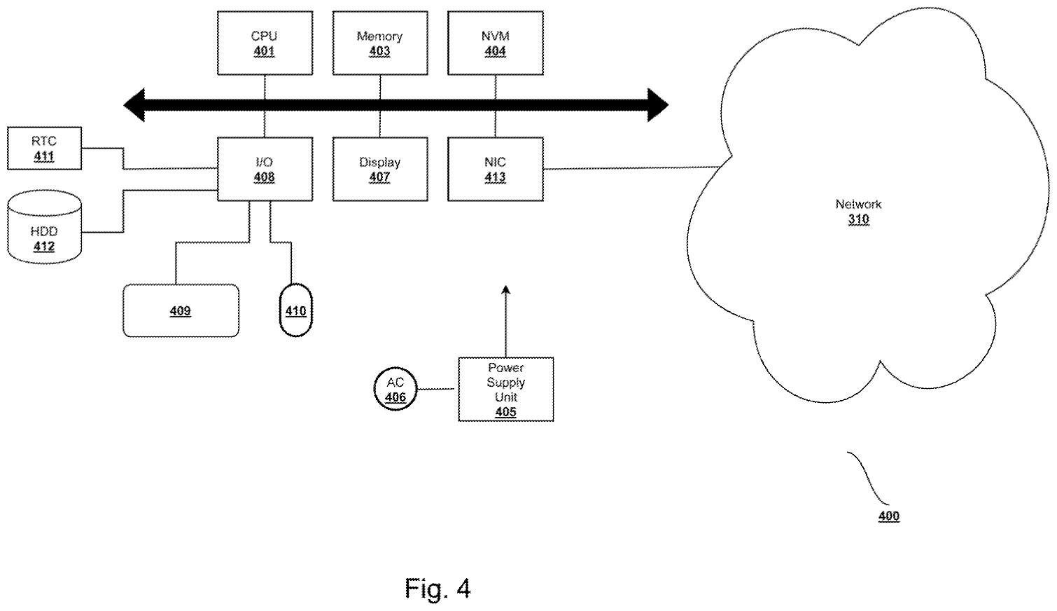

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or

Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

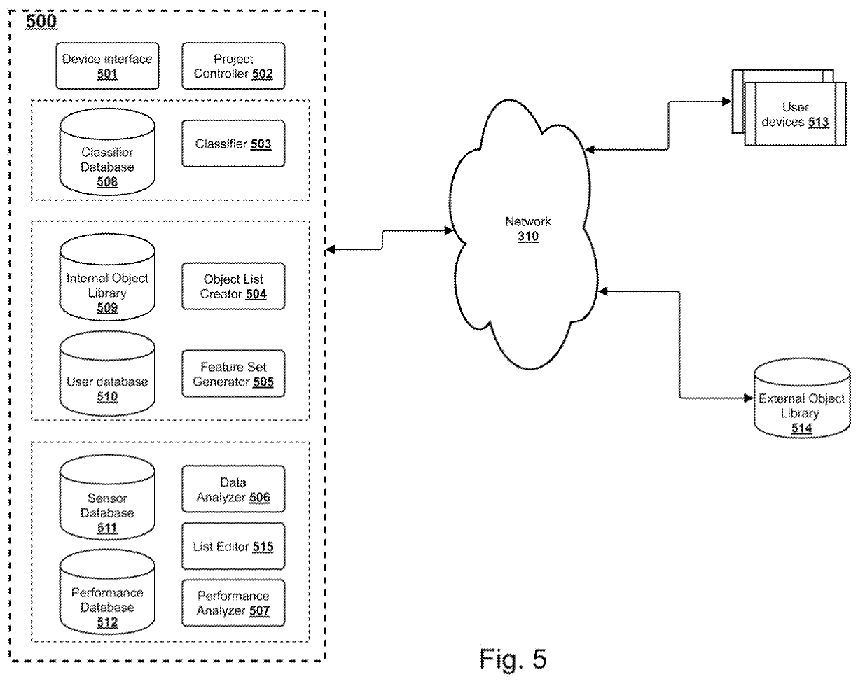

FIG. 5 is a block diagram of an exemplary system architecture for operating content object computer 500, according to a preferred embodiment of the invention. According to the embodiment, content object computer 500, in communication with a plurality of user devices 513, may comprise a plurality of programming instructions stored in a memory and operating on a processor of a network-connected computing device, and may be configured to communicate via network 310 such as the Internet or other data communication network. For example, content object computer 500 may be configured to communicate via a cloud-based protocol to receive interactions from a plurality of user devices 513, such as to enable one or more users to interact with content object computer 500 via a web browser, another software application, or a specially programmed user computer. For example, content object computer 500 may utilize network 310 for creation of a particular dynamic ordering of content objects (such as a music library for a given workout regime), or to communicate with an external object library 514 (such as a music application, e.g., Spotify™), via a local network connection such as a LAN operated by a user, or an internal data network operating on user device 513.

In some embodiments, content object computer 500 may further comprise device interface 501; project controller 502; classifier 503 and classifier database 508; object list creator 504 and internal object library 509; program generator 505 and user database 510; data analyzer 506 and sensor database 511; object editor 515; and performance analyzer 507 and performance database 512.

In an embodiment, device interface 501 may present information received from one or more user devices 513 through network 310. Further, project controller 502 may utilize the presented information to create a plurality of ordered lists of content objects. In the embodiment, classifier 503 may create one or more multilayer perceptron (MLP) classifiers to classify data points required for creating the plurality of ordered lists. The data points may comprise of exemplary audio segments, such as music files or soundtracks, received from user devices 513 and/or external object library 514. The data points may be classified by classifier 503 into one or more classification categories and third-party data may be collected for each data point. The third-party data may comprise data associated with a plurality of features for each data point. In some embodiments, wherein the data points are music files or soundtracks, the third-party data may comprise information pertaining to tempo, cadence, intensity, and the like for each music file or soundtrack. Further, classifier 503 may use the third-party data for each data point to create a training dataset for the one or more MLP classifiers used to classify the data points. The training dataset and the one or more MLP classifiers may be stored in classifier database 508.

According to an embodiment, object list creator 504 may create the plurality of ordered lists of content objects based on the classified data points stored within classifier database 508. In the embodiment, object list creator 504 may scan content objects stored in a memory of user device 513 and classifier 503 may classify the content objects based on the one or more MLP classifiers stored within classifier database 508. In some embodiments, the content objects may be classified within classification categories including, but not limited to, pre-classified, manually classified, and indirectly classified.

Further, based on the classification, object list creator 504 may compute a weighted score of attributes for each content object of the content objects. In a preferred embodiment, the weighted score may be indicative of an intensity level that a particular content object falls into, thereby suggesting a suitability of that particular content object for a particular feature set. In the embodiment, object list creator 504 may compute respective weighted scores for the attributes based on the third-party data received for each of the content objects. In an embodiment, the weighted scores are computed based at least on third-party metrics, such as danceability, energy, tempo (and potentially popularity, genre) received by content object computer 500 for each content object. Once the respective weighted scores are computed by object list creator 504, an ordered list for the content objects is created and presented to user device 513.

In an embodiment, during interaction of content object computer 500 with user device 513, content object computer 500 may receive a selected feature set from user device 513. In the embodiment, object list creator 504 may determine a plurality of features associated with the selected feature set. The feature set may comprise an exemplary workout regime such as walking, running, cycling, aerobics, high intensity interval training, and the like. The feature set may further comprise a selection of a musical genre received such as classical, rock, metal, and the like.

In an alternative embodiment, one or more feature sets may also be created by feature set generator 505. In the embodiment, feature set generator 505 may create a feature set based on preference data associated with user device 513 and stored within user database 510. The preference data may comprise historic biometric data, user credentials, user physiological data, user health data, and the like. Further, the generated feature set may comprise exemplary workout regimes created based on the preference data. The generated feature set may be associated with user device 513 and stored within user database 510.

Further, object list creator 504 may use data from one or more sensors associated with user device 513 as well as preference data to alter and optimize the weighted scores for the attributes of the one or more content objects, thus personalizing the categorizations and continually improving accuracy of the classification of the one or more content objects. Furthermore, feedback from subsequent biometric data and preference data may advantageously eliminate the content objects from categorization that were initially falsely weighted, thereby continually perfecting the categorization algorithm. In a preferred embodiment, the optimized weighted scores may be reflective of a quantified motivational impact of a certain content object. In the embodiment, each attribute of the content object may have a distinct effect on the overall motivational impact of the content object, and the associated weighted scores may quantify this motivational impact based on the effect. Further, each attribute of the content object may be assigned a weighted score, such that the weights are determined based on each attribute's output impact on an interaction of user device 513 on a particular feature set, measured both in real-time as well as based on historic user device data.

During operation of content object computer 500, data analyzer 506 may identify whether a particular user device 513 is currently interacting with a feature set. If such an interaction is determined, object list creator 504 may provide an ordered list of content objects to the user device 513 based on which feature set has been selected. Further, data analyzer 506 may analyze biometric data associated with user device 513.

In an embodiment, biometric data may include exemplary workout data associated with a user, such as heart rate, steps per minute, elevation, geographical terrain, distance covered, spent calories, and the like. Such biometric data may be stored by data analyzer 506 within the sensor database 511.

In an embodiment, based on analysis of the biometric data, list editor 515 may determine if the ordered list of content objects needs updating. According to the embodiment, the determination of updating the ordered list of content objects may be based on a comparison of the biometric data with one or more threshold values computed for respective intensity levels associated with the selected feature set. Each feature set may have an associated threshold value indicative of the intensity level and data analyzer 506 may compute a difference between the biometric data and the associated threshold value for the selected feature set during operation. Based on the computed difference, list editor 515 may dynamically update the ordered list of content objects and transmit the updated ordered list to user device 513. Further, based on the update in the ordered list of content objects as well as biometric data received from user device 513,

In some embodiments, user device 513 may either select the updated ordered list of content objects for playback or send an override signal to content object 500.

Further, in an embodiment, performance analyzer 507 may generate performance data for user device 513 based on the interaction of user device 513 with the selected feature set. In the embodiment, once user device 513 terminates interaction with the selected feature set, performance analyzer 507 may collect statistical data associated with the interaction and generate a performance report to be transmitted to user device 513. Further, performance analyzer 507 may store the generated performance data within performance database 512.

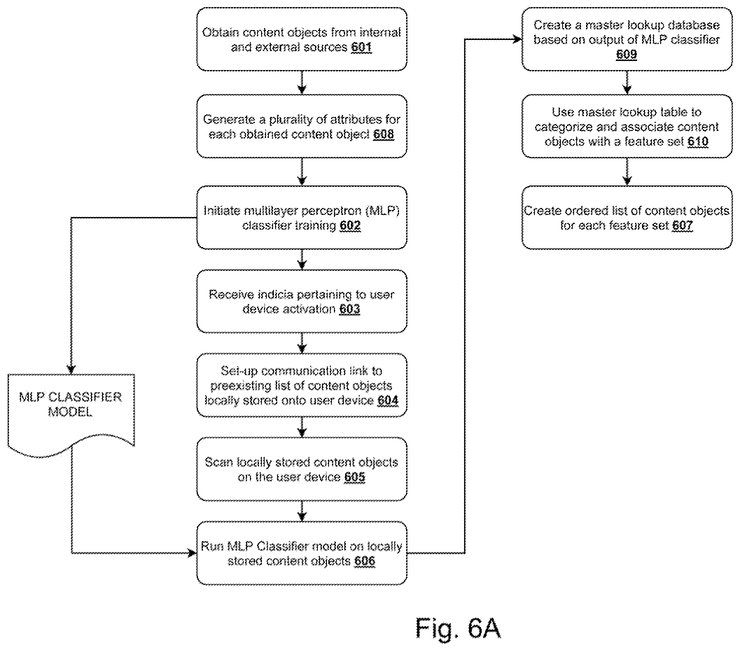

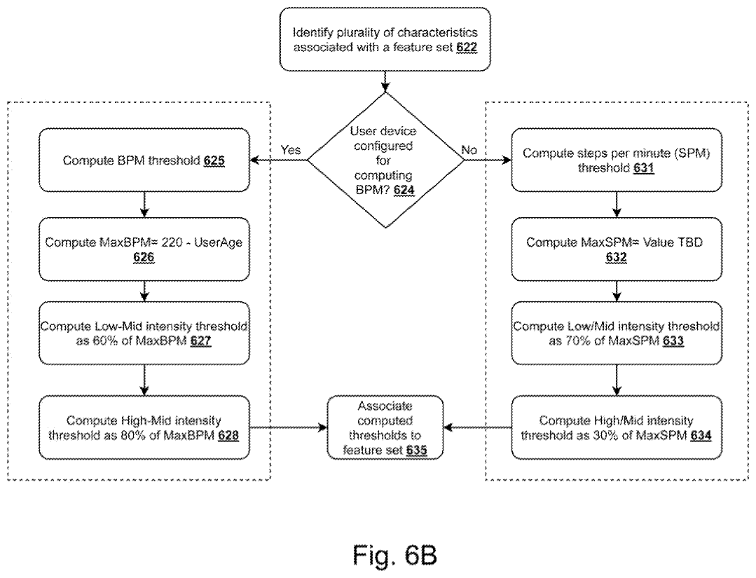

The aforementioned functions of content object computer 500, along with other preferred embodiments of the present invention, are described in greater detail below, in conjunction with FIGS. 6-10.

### DETAILED DESCRIPTION OF EXEMPLARY EMBODIMENTS

FIGS. 6A-B illustrate an exemplary method for categorization of a plurality of content objects based on a plurality of user device inputs combined with user biometric data, according to an embodiment of the invention. Referring to FIG. 6A, according to the embodiment, in a step 601, project controller 502 may receive one or more content objects from a plurality of external and internal sources. In an embodiment, the external sources, such as external object library 514 may include data from preapproved sources such as publicly available music libraries, third-party data providers, or music applications such as Apple™ Music, Spotify™, etc. Further, internal sources for the content objects may include data sourced from one or more internal libraries such as object library 509 or data received from a plurality of training professionals, workout applications, internally stored music libraries, and the like. The received one or more content objects may be stored in object library 509 and may be classified into one or more categories by classifier 503 using one or more classifiers.

In a next step 608, project controller 502 may generate a plurality of attributes for each received content object. In one embodiment, content objects may comprise exemplary soundtracks and the plurality of attributes may comprise data pertaining to energy, beats per minute (BPM), danceability, popularity, tempo, loudness, speech, acoustics, instruments, valence, and the like for each soundtrack. Further, in another embodiment, project controller 502 may further divide these received content objects based on their suitability for a feature set. In the embodiment, the feature set may comprise one or more exemplary workout routines and project controller 502 may divide the content objects based on how each determined attribute of a content object can be associated with a given workout routine.

In a next step 602, classifier 503 may initiate training of a multilayer perceptron (MLP) classifier to be used for classification of the received one or more content objects. In an embodiment, classifier 503 may use a variation of a neural network model comprising of tanh activation functions and a single hidden layer with 100 neurons, a total of 3 neurons on an input layer, and a total of 5 neurons on an output layer.

In a next step 603, project controller 502 may receive indicia pertaining to user device 513 activation. In an embodiment, such an indicia may comprise a notification affirming that an associated software application has been downloaded on user device 513. In the embodiment, a fitness application or a music application may be downloaded on user device 513, such that a user of user device 513 may create a subscription account and upload personal details to a server (not shown) associated with the software application. The personal details may include, but not limit to, biometric data, physiological data, bibliographic data, location data, and the like for a user of user device 513. Further, user device 513 may provide content object computer 500 rights to access the personal details of the user as well as a preexisting list of content objects locally stored within a memory of user device 513, through the software application.

In a next step 604, project controller 502 may set-up communication link to the preexisting list of content objects stored in a memory of user device 513. As described above, project controller 502 may set-up the communication link by using access rights to the software application downloaded to user device 513. Once the communication link is set-up, in a next step 605, project controller 502 may scan the preexisting list of content objects on user device 513. In some embodiments, the preexisting list of stored content objects may include an exemplary list of audio segments, such as music playlists, generated by the user using one or more music applications and stored in a memory of user device 513. Further, each list of audio segments may be categorized into one or more categories such as genre, preference, mood, tempo, and the like.

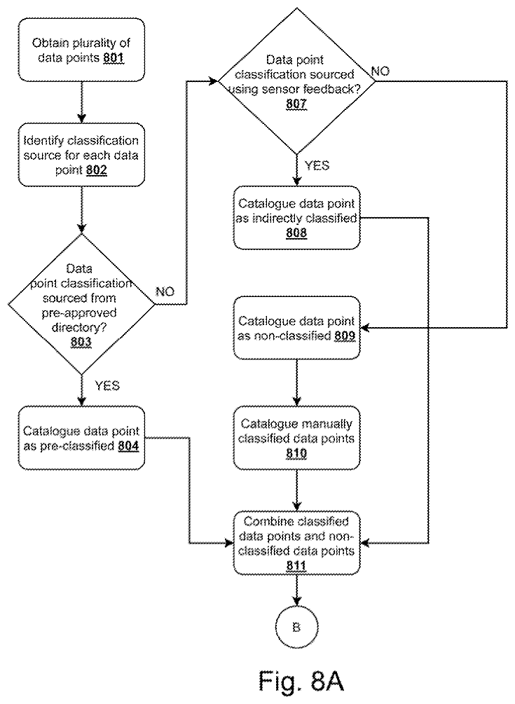

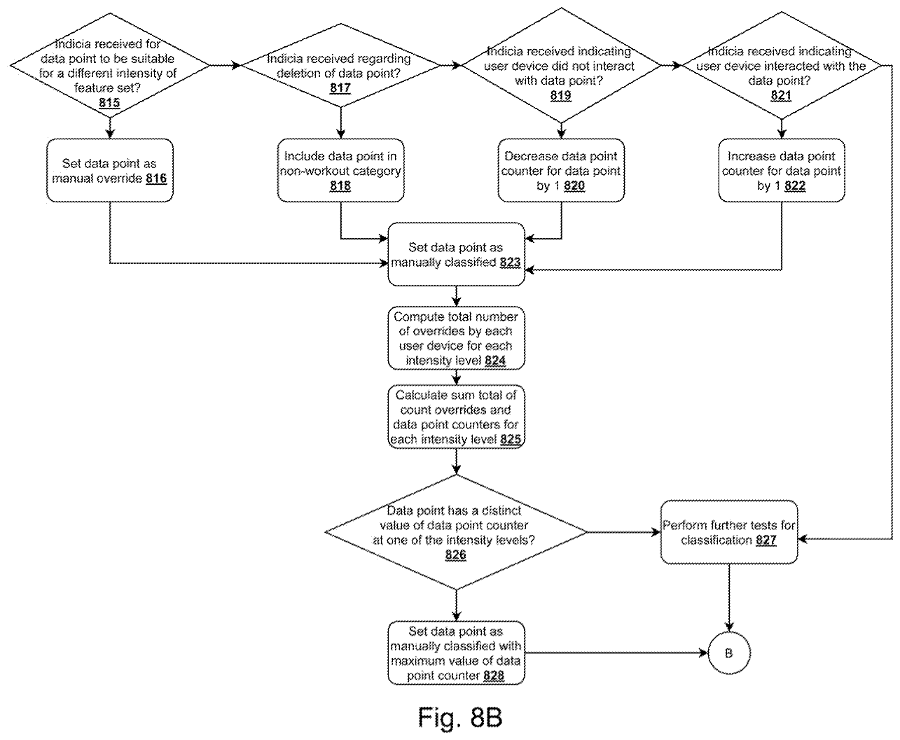

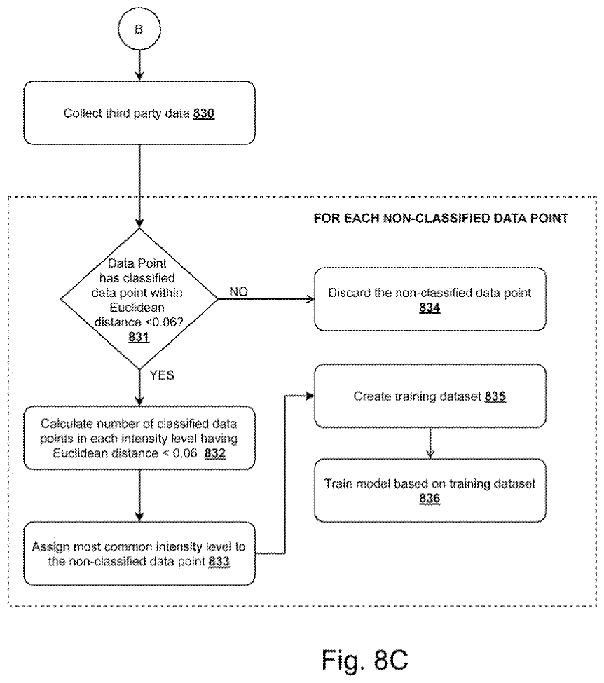

Referring again to FIG. 6A, in a next step 606, classifier 503 may run the trained MLP classifier on the list of stored content objects for user device 513. In an embodiment, classifier 503 may run the MLP classifier on the locally sourced content objects in order to classify each content object into one of a plurality of classification categories including, but not limiting to, pre-classified, manually classified, and indirectly classified classification categories using the trained MLP classifier (referring to FIGS. 8A-C). An exemplary routing for step 606 is as follows:

The initial neuron activation is set to a vector:

Activation⁰=[energy, dancebility, tempo]^{T}

For each layer, except the last one (the output layer), activation is calculated as follows:

Activationᵢ=tanh (Activationᵢ₋₁*Coefsᵢ+Interceptsᵢ)

Where i is the number of the neuron layer, Coefs is the matrix of neuron weights at i^{th} layer, Intercepts is the matrix of neuron intercepts at i^{th} layer.

On the last layer activation is calculated as follows:

$${Activation}_{last i} = \frac{\begin{matrix}exp ( {Activation}_{i - 1} * {Coefs}_{i} + {Intercepts}_{i} - \\ {max}_{by row} ( {Activation}_{i - 1} * {Coefs}_{i} + {Intercepts}_{i} ) )\end{matrix}}{\begin{matrix}Σ exp ( {Activation}_{i - 1} * {Coefs}_{i} + {Intercepts}_{i} - \\ {max}_{by row} ( {Activation}_{i - 1} * {Coefs}_{i} + {Intercepts}_{i} ) )\end{matrix}}$$

The output of the MLP is determined by identifying the number of the output with max value:

Out=maxarg(Activation_{last i})

The output may be one of 0, 1, 2, 3 ,4, where 0 may correspond to “non-workout” or “rejects”, 1 may correspond low intensity, 2 may correspond mid-low intensity, 3 may correspond mid-high intensity, 4 may correspond high intensity, and associated with the content objects.

In a next step 607, object list creator 504 may create a plurality of dynamic content objects. In an embodiment, the plurality of dynamic content objects may be created by object list creator 504 as an ordered list and presented to user device 513 for playback. In the embodiment, the ordered list of the plurality of dynamic content objects may be created by object list creator 504, such that each content object of the plurality of dynamic content objects may be associated with a portion of a feature set selected by user device 513. In some embodiments, the feature set may comprise of an exemplary workout regime, such as weight training, high intensity interval training, yoga, cycling, and the like. Some workout regimes may be unavailable to certain user devices 513, depending on whether a user device 513 contains the capability to calculate a certain set of biometric data values. Further, in one preferred embodiment, each feature set may comprise of an associated “intensity arc”, which may define an expected output intensity expected at each timeframe of the feature set.

In an embodiment, object list creator 504 may use the associated intensity arc an input value to determine a plurality of discrete intensity levels for the feature set. In the embodiment, the plurality of discrete intensity levels may comprise slow intensity, medium-slow intensity, medium-fast intensity, and fast intensity levels. In the embodiment, object list creator 504 may further determine time durations of each segment of the feature set having a constant intensity level.

In another embodiment, object list creator 504 may pick and select content objects that approximately cover each segment of the feature set at a desired intensity level. Based on such calculations, object list creator 504 may create the ordered list of content objects for the entire selected feature set. Further, based on the selected feature set and biometric data associated with user device 513, content object computer 500 may also edit the ordered list to tailor to the selected feature set (referring to FIG. 6B).

Referring again to FIG. 6A, in a next step 609 project controller 502 may create a master lookup dataset based on one or more outputs of the MLP classifier. In an embodiment, wherein the list of stored content objects include exemplary music tracks stored in a memory of user device 513, project controller 502 may create a master lookup dataset listing each music track with their respective attributes in a local database such as internal object library 509. Further, each such attribute may also be associated with a weighted score, such that a sum of all weighted scores may be indicative of a suitability of a music track to be used for a particular feature set execution. Based on such weighted scores for attributes, in a next step 610, project controller 502 may use the created master lookup dataset to categorize content objects and associate each content object with one or more feature sets. In an embodiment, the feature set may comprise exemplary workout routines and the content objects may comprise one or more exemplary music tracks. In the embodiment, project controller 502, may determine an association of each music track to one or more workout routines, based on the weighted scores for attributes such as energy, danceability, and tempo.

Further, in a next step 607, object list creator 504 may create an ordered list of content objects for each feature set.

Referring now to FIG. 6B, according to an embodiment, in step 622, feature set generator 505 may identify a plurality of characteristics associated with one or more feature sets. In one embodiment, the plurality of characteristics may at least include an intensity level range associated with each feature set. The intensity level range may be reflective of appropriate biometric readings, and/or other factors recommended for different timeframes within the feature set. In the embodiment, the intensity level range may be computed by feature set generator 505 as indicative of optimal intensity levels required to reach a predetermined goal, when user device 513 interacts with the selected feature set.

In a next step 624, data analyzer 506 may determine whether user device 513 is configured for computing a particular user biometric. In an embodiment, the user biometrics may be selected by data analyzer 506 based on the identified intensity level range. The user biometrics, in some embodiments, may include heart rate, distance, or cadence data. In other embodiments, the user biometric data may also comprise data pertaining to elevation, temperature, and one or more selection factors for the content objects.

In one embodiment, the particular user biometric may include beats per minute (BPM). In another embodiment, the particular user biometric may include steps per minute (SPM). In embodiments where the user biometric includes BPM, responsive to a determination by data analyzer 506 that user device 513 is configured for computing BPM values project controller 502 may compute BPM threshold values by performing steps 626-628.

In step 626, project controller 502 may calculate a maximum threshold of BPM using the following exemplary sequence:

MaxBPM=220−userAge,

wherein MaxBPM denotes the maximum threshold value for BPM and userAge denotes a value of age for a user associated with user device 513.

In a next step 627, project controller 502 may compute a Low-Mid intensity threshold using the following exemplary sequence:

Low−Mid=0.6×MaxBPM,

wherein Low-Mid denotes the low-mid intensity threshold. The low-mid intensity threshold may be indicative of a minimum value of BPM that may be ideal for a given period of time in the selected feature set. For instance, when the selected feature set comprises of running as the workout, the low-mid threshold for BPM may be indicative of an ideal BPM value when a user is jogging towards the start of the workout and while cooling down towards the end of the workout.

In a next step 628, project controller 502 may compute a High-Mid intensity threshold using the following exemplary sequence:

High−Mid=0.8×MaxBPM,

wherein High-Mid denotes the high-mid intensity threshold. The high-mid intensity threshold may be indicative of a maximum value of BPM that may be ideal for a given period of time in the selected feature set. For instance, when the selected feature set comprises of running as the workout, the high-mid threshold for BPM may be indicative of an ideal BPM value when a user is running during a peak time in the workout.

Referring again to step 624, if it is determined, by project controller 502, that user device 513 is not configured for computing thresholds for BPM, in next steps 631-634, project controller 502 may compute a steps per minute (SPM) threshold instead.

In a next step 632, project controller 502 may calculate a maximum threshold of SPM using the following exemplary sequence:

MaxSPM=TBD,

wherein MaxSPM denotes the maximum threshold value for SPM.

In a next step 633, project controller 502 may compute a Low-Mid intensity threshold for SPM using the following exemplary sequence:

Low−Mid=0.7×MaxSPM,

wherein Low-Mid denotes the low-mid intensity threshold.

In a next step 628, project controller 502 may compute a High-Mid intensity threshold for SPM using the following exemplary sequence:

High−Mid=0.3×MaxSPM,

wherein High-Mid denotes the high-mid intensity threshold.

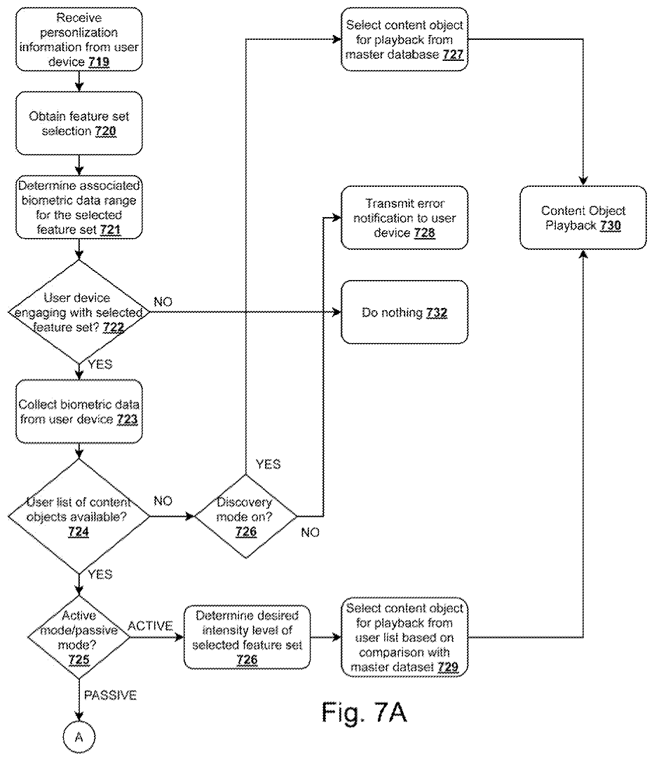

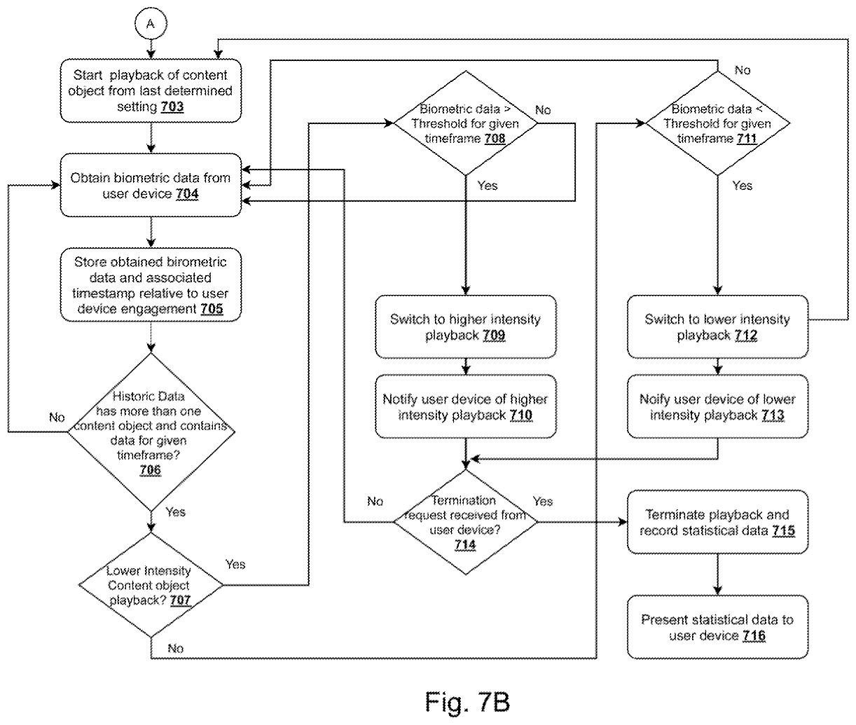

Referring again to FIG. 6B, in a preferred embodiment, the above described thresholds may be computed by data analyzer 506 for each feature set. Further, in a next step 635, respective thresholds for biometric data may be associated with given time frames in each feature set by project controller 502. In the embodiment, these thresholds may be utilized by content object computer 500 for dynamically updating ordered lists of content objects during interaction of user device 513 with respective feature sets, as described in detail with respect to FIGS. 7A-B.

FIGS. 7A-B illustrate an exemplary method for generating an ordered listing of content objects based on device engagement with a feature set, according to an embodiment of the invention.

Referring to FIG. 7A, in step 719, project controller 502 may receive personalization information from user device 513. In an embodiment, the personalization information may include, biometric data, physiological data, bibliographic data, location data, and the like for a user of user device 513.

Further, in a next step 720, project controller 502 may receive a feature set selection from user device 513. In an embodiment, the feature set may comprise of exemplary workout routines such as running, high intensity interval training (HIIT), yoga, and the like. In an embodiment, in case there are no feature sets available for selection, feature set generator 505 may create one or more feature sets based on the personalization information received from user device 513.

In a next step 721, project controller 502 may compute biometric data range for the selected feature set. In an embodiment, project controller 502 may compute the biometric data range comprising threshold values for each biometric in different timespans in the selected feature set. The threshold values may be computed by project controller 502 as described in the foregoing with respect to FIG. 6B. Further, in a next step 722, project controller 502 may determine whether user device 513 is engaging with the currently selected feature set. If it is determined, by project controller 502, that user device 513 is not engaging with the currently selected feature set, in a next step 732, project controller 502 may not perform any action.

Otherwise in a next step 723, project controller 502 may collect biometric data from user device 513. In an embodiment, the biometric data may comprise of BPM and SPM readings received from user device 513, when user device 513 engages with the selected feature set. In a next step 724, project controller 502 may determine whether a user list of one or more content objects is available. In an embodiment, the user list of content objects may comprise of a list of content objects stored in a memory of user device 513.

In case a determination is made by project controller 502, that no such user list of content objects is available, in a next step 726, project controller 502 may further determine whether a discovery mode is active on user device 513. If the discovery mode is inactive, in a next step 728, project controller 502, may transmit an error notification to user device 513. In some embodiments, the error notification may comprise of an error message indicating that no content objects are available for playback. In other embodiments, project controller 502 may also transmit an upload link to user device 513 to enable user device 513 to upload a list of content objects. Further, project controller 502 may also transmit a link to user device 513 to activate the discovery mode.

Referring back to FIG. 7A in case a determination is made by project controller 502, that the discovery mode is active on user device 513, in a next step 727, project controller 502 may select a content object from the master lookup dataset for playback.

In an embodiment, the content object for playback may be selected based on personalization information, feature set selection, and biometric data as received from user device 513. Further, in a next step 730, project controller 502 may transmit the selected content object for playback to user device 513.

Referring again to step 724, in case project controller 502 determines that the user list of content objects is available, in a next step 725, project controller 502 may determine whether user device 513 is engaging with the feature set using an active mode or a passive mode. In case of a passive mode selection, the method may continue to FIG. 7B.

Otherwise, in case of an active mode being selected by user device 513, in a next step 726, feature set generator 505 may determine a desired intensity level of the selected feature set. In an embodiment, wherein the selected feature set comprise of an exemplary workout routine, the desired intensity level may be indicative of how a user of user device 513 has selected to perform said workout routine, e.g., vis-à-vis level of exertion, personal goals, desired biometric readings, distance objectives, and the like.

Further, based on the computed desired intensity level, project controller 502 may select a content object for playback at user device 513, through comparison of the available user list with content objects stored in the master lookup dataset. In several embodiments, such a comparison may include comparing weighted scores of attributes for content objects in the user list to weighted scores of attributes for the content objects stored in the master lookup dataset. In such embodiments, project controller 502 may select the content object for playback based on how accurately a content object from the user list matches the content object stored in the master lookup dataset, for the computed intensity level.

Again, in step 730, project controller 502 may transmit the selected content object for playback to user device 513.

Referring now to FIG. 7B, in a step 703, object list creator 504 may start playback of a content object based on a last determined setting (referring to FIG. 7A). In an embodiment, the content to be played back to user device 513 may be selected by object list creator 504 based on a passive mode or an active mode selected on user device 513. In the embodiment, the content object may comprise of an exemplary list of audio segments, such as music playlists, played back to user device 513. Further, the playback by object list creator 504 to user device 513, may be such that for each given timeframe of the selected feature set, an appropriate content object is provided to user device 513.

In a next step 704, data analyzer 506 may receive biometric data from user device 513. In an embodiment, the biometric data may comprise data generated by user device 513 based on interaction of user device 513 with the selected feature set. In the embodiment, the selected feature set may comprise of exemplary workout regimes and the biometric data may comprise of information pertaining to user performance, such as BPM, SPM, calories spent, distance covered, elevation, and the like. Further, the biometrics data may be transmitted by user device 513 in real-time to content object computer 500.

In a next step 705, data analyzer 506 may store received biometric data along with an associated timestamp relative to user device engagement. In some embodiments, each timestamp may be indicative of a particular point in the selected feature set that user device 513 is interacting with, along with a content object being played back at that particular point. In an embodiment, data analyzer 506 may store the received biometric data and the associated timestamp in sensor database 511.

In a next step 706, project controller 502 may determine whether historic data linked to user device 513 contains more than one content object for a particular time frame. In an embodiment, the historic data may comprise of previously stored biometric data and timestamps for user device 513 stored by data analyzer 506 within sensor database 511. Further, in the embodiment, the particular time frame may be an interval of 10 seconds. If it is determined by project controller 502 that historic data linked to user device 513 does not contain more than one content object for the given timeframe, the method may continue to step 704. In an embodiment, if project controller 502 determines that there is no historic data available for user device 513, data analyzer 506 may continue to receive biometric data from user device 513.

Otherwise, in a next step 707, project controller 502 may determine whether a content object being played is associated with a lower intensity of the selected feature set. In an embodiment, the selected feature set may comprise of an exemplary workout routine, wherein the exemplary workout routine may be divided into timeframes by project controller 502, each timeframe having different intensity levels associated with them. In the embodiment, the exemplary workout routine may be running, and appropriate values for heartbeats per minute, steps per minute, or other recommended intensity factors at different points in the workout routine may be predetermined by project controller 502.

Referring again to FIG. 7B, If it is determined by project controller 502 that the content object being played is associated with the lower intensity, in a next step 708, project controller 502 may further determine whether value of a currently investigated biometric data is greater than a computed threshold value for the given timeframe. If it is determined by project controller 502 that the value of the currently investigated biometric data is not greater than the threshold value, the method may continue to step 704. In an embodiment, if project controller 502 determines that the value of the currently investigated biometric data is not greater than the threshold value, data analyzer 506 may continue to receive biometric data from user device 513.

Otherwise, if it is determined by project controller 502 that the value of the currently investigated biometric data is greater than the threshold value, in a next step 709, list editor 515 may switch the playback to a content object associated with a higher intensity of the currently selected feature set. In one embodiment, wherein the content object being played back comprises an audio segment, such as a music file, and wherein the currently investigated biometric data comprises BPM, project controller 502 may determine whether the received BPM values from user device 513 are greater than a precomputed threshold for BPM for the given timeframe, e.g., 10 seconds. If such a determination is made by project controller 502, list editor 515 may identify another content object that may be more appropriate for the received values of BPM from user device 513, e.g., associated with a higher intensity of the selected feature set. In an embodiment, project controller 502 may transmit a notification to user device 513 indicating that the playback of a current content object be terminated, and a different content object be played. Further, project controller 502 may receive a response to the notification from user device 513 stating whether change in the playback is accepted or rejected. If project controller 502 receives a rejection to the change in playback, the method may continue to step 704. Otherwise, the identified content object may be played back by project controller 502 to user device 513. Further, in a next step 710, list editor 515 may also transmit a notification to user device 513 indicating successful change in playback. The method may then continue to step 714.

Referring again to step 707, if it is determined by project controller 502 that the content object being played is not associated with a lower intensity of the selected feature set, in a next step 711, project controller 502 may determine whether value of the currently investigated biometric data is lower than a threshold value for the given timeframe. If it is determined by project controller 502 that the value of the currently investigated biometric data is not lower than the threshold value for the given timeframe, the method may continue to step 704. In an embodiment, if project controller 502 determines that the value of the currently investigated biometric data is not lower than the threshold value, data analyzer 506 may continue to receive biometric data from user device 513.

Otherwise, if it is determined by project controller 502 that the value of the currently investigated biometric data is lower than the threshold value for the given timeframe, in a next step 709, list editor 515 may switch the playback to a content object associated with a higher intensity of the currently selected feature set. In one embodiment, wherein the content object being played back comprises an audio segment, such as a music file, and wherein the currently investigated biometric data comprises SPM, project controller 502 may determine whether the received SPM values from user device 513 are greater than a precomputed threshold value of the SPM for the given timeframe, e.g., 10 seconds. If such a determination is made by project controller 502, list editor 515 may identify another content object that is appropriate for the received values of SPM from user device 513, i.e., associated with a lower intensity of the selected feature set. The identified content object may then be played back by project controller 502 to user device 513.

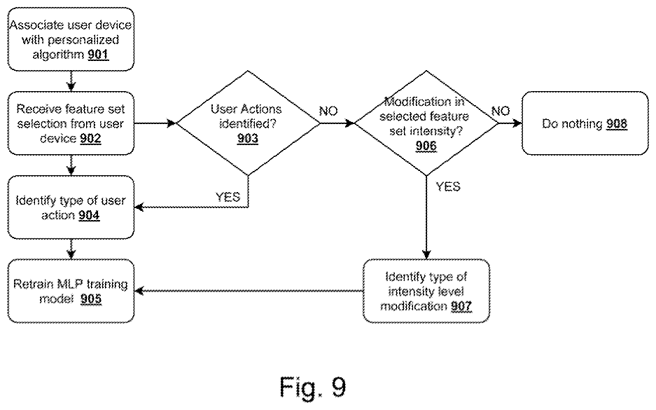

In a preferred embodiment, such modifications in the playback of content objects by list editor 515 may be advantageous in ensuring that each time an intensity level of a user, as determined through biometric data received from user device 513, does not match with the desired intensity levels of the feature set (e.g., in a workout routine), a change in playback is triggered such that the user is motivated to match the desired intensity level. Further, each such modification in content object playback may be identified by classifier 503 and used to retrain the MLP classifier for increased accuracy in content object suggestions to user device during future interactions with said feature set, as described in detail with reference to FIG. 9.

Referring again to FIG. 7B, in a next step 710, list editor 515 may also transmit a notification to user device 513 indicating the successful change in playback. The method may then continue to step 714. Further, in the step 714, project controller 502 may determine whether a termination request has been received from user device 513. In case it is determined by project controller 502 that a termination request is not received, the method may continue to step 704. That is, if project controller 502 determines that no termination request is received from user device 513, data analyzer 506 may continue to receive biometric data from user device 513.

Otherwise, in a next step 715, project controller 502 may terminate the playback of content objects and performance analyzer 507 may collect statistical data associated with user device 513. In some embodiments, the collected statistical data may comprise exemplary workout routine data associated with user device 513. In the embodiments, the workout routine data may include a comparison of user biometric data values with one or more threshold values generated for the selected feature set. Further, the workout routine data may further comprise of indicators reflecting data pertaining to total time elapsed during the workout routine; total distance covered during the workout routine; total calories burnt during the workout routine; elevation data associated with the workout routine, and the like. Further, in a next step 716, performance analyzer 507 may present collected statistical data to user device 513.

FIGS. 8A-C illustrate an exemplary method for creating a multilayer perceptron (MLP) classifier for classification of a plurality of content objects, in accordance with a preferred embodiment of the present invention. Referring to FIG. 8A, according to the embodiment, the method may start at step 801, wherein classifier 503 may receive a plurality of data points. In an embodiment, the plurality of data points may comprise exemplary audio tracks received from one or more external and/or internal sources, such as external object library 514, internal object library 509, internet, third-party data providers, music applications, and the like.

In a preferred embodiment, classifier 503 may perform steps 801-828 to segregate the plurality of data points into respective classification types. In an embodiment, the classification types may comprise pre-classified data points, manually classified and re-classified data points, indirectly classified data points, non-classified data points, and data points having no associated classification data. The method may then continue to step 811.

Referring to FIG. 8A, in a step 803, classifier 503 may determine whether the classification of a given data point is sourced from a pre-approved directory. In an embodiment, the pre-approved directory may comprise of data points received from trusted external sources, for example, a list of audio tracks uploaded by a plurality of trainer devices (not shown), to the content object computer 500. In the embodiment, if it is determined by classifier 503 that the given data point is sourced from the pre-approved directory, in a next step 804, the given data point is catalogued by classifier 503 within the pre-classified classification type.

However, if it is determined by classifier 503 that the given data point is not sourced from the pre-approved directory, in a next step 807, classifier 503 may further determine whether the classification for the data point is sourced using feedback from one or more sensors associated with user device 513. In an embodiment, the feedback from the one or more sensors may comprise information regarding data point skipped for playback by user device 513 during interaction with a particular feature set; data point that having a greater playback frequency than other data points; data point marked as favorite by user device 513; or any other data point identified as more suitable than other data points based on one or more actions performed by user device 513. In the embodiment, if it is determined by classifier 503 that the classification for the data point is sourced using feedback from one or more sensors, in a next step 808, classifier 503 may catalogue the data point as indirectly classified. The method may then continue to step 811.

Otherwise, in a next step 809, classifier 503 may catalogue the data point as non-classified. In an embodiment, the data points categorized into the non-classified classification type may have no classification data available. Further, in a next step 810, classifier 503 may catalogue all manually classified data points, as further described in conjunction with FIG. 8B. The method may then continue to step 811, wherein classifier 503 may combine the classified and non-classified data points.

FIG. 8B illustrates a method for manual classification of one or more data points, in accordance with a preferred embodiment of the invention. In the embodiment, in a step 815, classifier 503 may determine whether indicia is received indicating that a data point is suitable for a different intensity of a selected feature set than originally classified. In an embodiment, the data point may comprise of an exemplary audio track associated with a given intensity level of the selected feature set. However, during interaction of user device 513, an indication may be received by content classifier 503 that said exemplary audio track is suited for a different intensity level for the selected feature set. For instance, a user of user device 513 may manually terminate the playback of the audio track during a certain intensity level and start playback during a different intensity level. If frequent such indications for said data point are received by classifier 503, in a next step 816, classifier 503 may set the data point to a manual override.

However, if no such indicia is received, in a next step 817, classifier 503 may determine whether an indicia is received regarding deletion of the data point. If such an indicia is received by classifier 503, in a next step 818, classifier 503 may include the data point in a non-workout category. In an embodiment, the indicia regarding deletion of the data point may either be received by classifier 503 during interaction of user device 513 or during an initial stage of creation of the ordered list of content objects by content object computer 500. For example, the data point may be an exemplary audio track that may be too slow in tempo, have prolonged periods of quiet or talking, and/or excessively negative lyrics, and therefore may be deleted by user device 513.

However, if such an indicia has not been received by classifier 503, in a next step 819, classifier 503 may determine whether indicia is received for the data point indicating that user device 513 did not interact with the data point. If it is determined by classifier 503 that such an indicia has been received, in a next step 820, classifier 503 may decrease a data point counter for the data point by 1. Otherwise, in a next step 821, classifier 503 may determine whether indicia is received indicating that user device 513 interacted with the data point. If such an indicia is received by classifier 503, in a next step 822, classifier 503 may increase the data point counter for the data point by 1. If not, the method continues to step 827.

In a next step 823, classifier 503 may categorize the data point in a manually classified classification type. Further, in a next step 824, classifier 503 may compute a count of overrides and data point counters for each data point at each intensity level of the selected feature set. In a next step 825, classifier 503 may calculate a sum total of count of overrides and data point counters for all data points at each intensity level of the selected feature set.

In a next step 826, classifier 503 may determine whether a data point has a distinct value of data point counters at a given intensity level of the selected feature set. If it determined by classifier 503 that the data point has a distinct value of data point counters at the given intensity level, in a next step 828, classifier 503 may set the data point as manually classified with the maximum value of the associated data point counter. Otherwise, in a next step 827, classifier 503 may perform further tests to determine classification information for the data point. The method may then continue to FIG. 8C.

Referring now to FIG. 8C, a method for creating a training model for an MLP classifier is illustrated according to a preferred embodiment of the present invention. In the embodiment, the method may start at a step 830, wherein classifier 503 may collect third party data associated with one or more data points. In an embodiment, the one or more data points may comprise of exemplary audio tracks and the third party data may include data regarding tempo, danceability, energy, etc.

Further, classifier 503 may perform steps 831-836 for each non-classified data points, as described in conjunction with FIG. 8B.

In step 831, classifier 503 may determine whether a non-classified data point has a classified data point within a Euclidean distance of less than 0.6. In case there are no such classified data points identified, in a next step 834, classifier 503 may discard the non-classified data point.

Otherwise, in a next step 832, classifier 503 may calculate a number of classified data points at each intensity level of the selected feature set, that have a Euclidean distance of less than 0.6 from the non-classified data point.

In a next step 833, classifier 503 may assign a most common intensity level of the selected feature set to the non-classified data set. In a next step 835, classifier 503 may create a training dataset. The training dataset may comprise of the third party data and the intensity levels for the selected feature sets. In a next step 836, classifier 503 may train the MLP classifier using the created training dataset.

In a preferred embodiment, the categorizations for the data points are based on plurality of meta-data variables such as BPM, energy, genre, popularity, valence, etc. The meta-data may be compiled by content object computer 500 from third-party music apps, such as Spotify™, and stored as the master lookup dataset to reference as data points pulled in from a Master Playlist. The way the weight of the variables initially calculated may be based on a mapping of several thousand of content object lists.

FIG. 9 illustrates an exemplary method to retrain a multilayer perceptron (MLP) classifier, according to a preferred embodiment of the present invention.

In the embodiment, in a step 901, project controller 502 may associate a generated MLP classifier (referring to FIGS. 6A and 8A-8C) with user device 513.

In a next step 902, project controller 502 may receive a feature set selection from user device 513. In a next step 903, project controller 502 may determine whether user actions are received from user device 513. In an embodiment, the content objects being played at user device at a particular time may comprise of exemplary music tracks and the user actions may comprise feedback from user device 513. Further, in a next step 904, project controller 502 may determine the type of user action. In an embodiment, the type of user action may comprise certain content objects played repeatedly, skipped from playback, deleted from the list of content objects or recategorized for a feature set different from the selected feature set. Such feedback from user device 513 may then be used by project controller 502 to recalculate the weighted scores for attributes associated with the content objects and thereby recalibrate the master lookup dataset.

Referring again to FIG. 9, in case it is determined that no user actions are received from user device 513, in a next step 906, project controller 502 may further determine whether a modification in intensity level of the selected feature set is identified. If no modification in the intensity level is identified by project controller 502, in a next step 908, project controller 502 may perform no action.

Otherwise, in a next step 907, project controller 502 may identify a type of modification in the intensity level of the selected feature set. In an embodiment, the modification in the intensity level may be indicative of a change in the interaction of user device 513 with the selected feature set, from originally computed biometric data for the selected feature set. Further, in the embodiment, the feature set may comprise of a workout routine, such as running, and the change in interaction may be indicative of a user of user device 513 running faster when a certain content object is played back.

Referring again to FIG. 9, in a next step 905 classifier 503 may retrain the MLP training dataset based on either the identified user action or the identified modification in intensity level of the selected feature set. In an embodiment, classifier 503 may retrain the MLP training dataset by first categorizing each content object stored within the master lookup dataset, when a modification in the intensity level and/or a user action is received from user device 513 by project controller 502. Further, from the MLP training dataset, classifier 503 may assign each content a category based on the collaborative output of the original MLP classifier as well as the retrained MLP classifier (the category with max number of votes wins, in case of equal number of votes use the categorization result of the original MLP classifier).

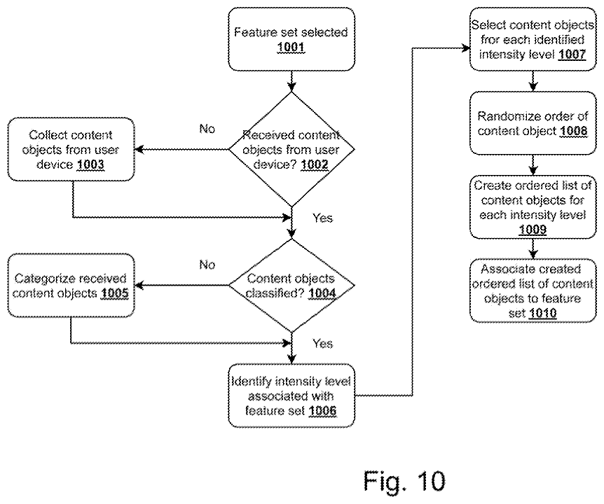

FIG. 10 illustrates an exemplary method for associating one or more content objects with a selected feature set, in accordance with a preferred embodiment of the invention.

According to the embodiment, in a step 1001, classifier 503 may select a feature set (or receive a selection from user device 513).

In a next step 1002, project controller 502 may determine whether one or more content objects are received from user device 513. If it is determined by project controller 502 that the one or more content objects are not received, in a next step 1003, project controller 502 may collect the one or more content objects from user device 513.

Otherwise, in a next step 1004, classifier 503 may determine whether the received one or more content objects have been classified. If it is determined by classifier 503 that the one or more content objects have not been classified, in a next step 1005, classifier 503 may categorize the one or more content objects.

However, if the one or more content objects have been classified, in a next step 1006, project controller 502 may identify an intensity level associated with the selected feature set.

In a next step 1007, object list creator 504 may select content objects from the one or more content objects that are associated with the identified intensity level of the feature set.

In an embodiment, the received one or more content objects may comprise of exemplary audio segments having a variety of genres. Further, classifier 503 may sort the one or more content objects on a scale according to their generic suitability for different intensity levels. In an example, some received audio segments may be rejected from classification process due to the audio segments being too slow in tempo, having prolonged periods of quiet or talking, and/or having excessively negative lyrics. In another example, some of the audio segments may be suitable for a warm-up or cool-down period of the feature set, since these audio segments may have a moderate-low tempo, have gentler vocals, and/or have neutral lyrical content. In yet another example, some audio segments may be suitable for moderate exertion periods in the feature set, since these audio segments may have a moderate tempo, have generally positive lyrics, and/or have loud vocals. Further, some of the audio segments may be categorized for peak performance, since these audio segments have fast tempo, and/or have a chorus that conveys movement or individuality.

Referring again to FIG. 10, in a next step 1008, object list creator 504 may randomize an order of the selected content objects.

In a next step 1009, object list creator 504 may create an ordered list of content objects for each identified intensity level for the selected feature set.

In a next step 1010, object list creator 504 may associate the created ordered list of content objects to the selected feature set.

The skilled person will be aware of a range of possible modifications of the various embodiments described above. Accordingly, the present invention is defined by the claims and their equivalents.

What is claimed is:

1. A system for generating an ordered list of content objects, the system comprising:
a network-connected content object computer comprising a memory, a processor, and a plurality of programming instructions, the plurality of programming instructions when executed by the processor cause the processor to:
receive a first plurality of content objects from one or more datastores over a network;
generate a plurality of attributes for each content object of the first plurality of content objects;
compute weighted scores for each of the plurality of attributes, wherein a sum of all computed weighted scores for a content object is indicative of a suitability of association of the content object with a feature set execution;
generate a master lookup dataset comprising temporal relationships between the content object, a sum of computed weighted scores for the content object, and a mapping between the content object and a feature set execution;
identify a second plurality of content objects stored in a memory of the user device;
determine one or more feature sets associated with the user device;
create an ordered list of the second plurality of content objects by associating each content object from the second plurality of content objects with at least one of the one or more feature sets based on the master lookup dataset; and
send the ordered list of the second plurality of content objects to the user device.

2. The system of claim 1, wherein the programming instructions, when further executed by the processor, cause the processor to compute the weighted scores for each of the plurality of attributes based on third-party data associated with each of the plurality of attributes.

3. The system of claim 1, wherein the programming instructions, when further executed by the processor cause the processor to:
receive a feature set selection from the user device;
determine whether the user device is interacting with the selected feature set;
in response to a determination that the user device is interacting with a selected feature set, collect biometric data from user device; and
select a content object for playback on the user device, from the ordered list of second plurality of content objects, based at least on the collected biometric data.

4. The system of claim 3, wherein the programming instructions, when further executed by the processor cause the processor to:
upon a determination that the pre-generated list of content objects is stored in the memory of the user device, determine a value of intensity level associated with the selected feature set; and
select a content object for playback on the user device, based on the determined value of intensity level.

5. The system of claim 4, wherein the programming instructions, when further executed by the processor cause the processor to:
identify, for the selected feature set, an intensity level range associated with the selected feature set;
determine a user biometric compatible with the user device;
compute, for the intensity level range, a plurality of threshold values comprising a high intensity threshold, a low-mid intensity threshold, and high-mid intensity threshold for the compatible user biometric; and
select a content object for playback on the user device, from the ordered list of second plurality of content objects, based on a comparison of the collected biometric data with the plurality of threshold values.

6. The system of claim 3, wherein the programming instructions, when further executed by the processor cause the processor to:
upon a determination that the list of pre-generated list of content objects is not stored in the memory of the user device, select a content object from the master lookup dataset for playback on the user device.

7. The system of claim 1, wherein the programming instructions, when further executed by the processor cause the processor to:
receive a feature set selection from the user device;
identify an intensity level range for the selected feature set;
for each intensity level in the intensity level range, select one or more content objects from the ordered list of second plurality of content objects;
randomize an order of the selected one or more content objects;
create an ordered list of the selected one or more content objects; and
associated the ordered list of the selected one or more content objects with the selected feature set.

8. The system of claim 1, wherein the programming instructions, when further executed by the processor cause the processor to:
start playback of a content object, from the ordered list of the second plurality of content objects, on the user device;
receive biometric data from the user device;
determine whether historic data stored for the user device contains more than one content object for a given period of time;
in response to a determination that the historic data for the user device contains more than one content object for a particular period of time, compare the biometric data received from user device to threshold data for the particular period of time; and
switch the playback to another content object from the ordered list of the second plurality of content objects on the user device, based on the comparison.

9. The system of claim 1, wherein the programming instructions, when further executed by the processor cause the processor to:
determine, in response to switching playback to another content object, whether a user device action is received from the user device;
if a user device action is received, identify the type of user device action; and
modify the playback based on the identified type of user device action.

10. The system of claim 9, wherein the identified type of user device action is a termination request;
wherein the programming instructions, when further executed by the processor cause the processor to:
terminate playback of a content object currently played on the user device and record statistical data associated with the user device; and
present the statistical data for display on the user device.

11. A computer-implemented method for generating an ordered list of content objects the method comprising:
receiving, a network-connected content object computer, a first plurality of content objects from one or more datastores over a network;
generating, by the content object computer, a plurality of attributes for each content object of the first plurality of content objects;
computing, by the content object computer, weighted scores for each of the plurality of attributes, wherein a sum of all computed weighted scores for a content object is indicative of a suitability of association of the content object with a feature set execution;
generating, by the content object computer, a master lookup dataset comprising temporal relationships between the content object, a sum of computed weighted scores for the content object, and a mapping between the content object and a feature set execution;
identifying, by the content object computer, a second plurality of content objects stored in a memory of the user device;
determining, by the content object computer, one or more feature sets associated with the user device;
creating, by the content object computer, an ordered list of the second plurality of content objects by associating each content object from the second plurality of content objects with at least one of the one or more feature sets based on the master lookup dataset; and
sending, by the content object computer, the ordered list of the second plurality of content objects to the user device.

12. The method of claim 11, further comprising the step of computing, by the content object computer, the weighted scores for each of the plurality of attributes based on third-party data associated with each of the plurality of attributes.

13. The method of claim 11, further comprising the steps of:
receiving, by the content object computer, a feature set selection from the user device;
determining, by the content object computer, whether the user device is interacting with the selected feature set;
in response to a determination that the user device is interacting with a selected feature set, collecting, by the content object computer, biometric data from user device; and
providing, by the content object computer, a content object for playback on the user device, from the ordered list of second plurality of content objects, based at least on the collected biometric data.

14. The method of claim 13, further comprising the steps of:
upon a list of a pre-generated list of content objects being stored in the memory of the user device, determining, by the content object computer, a value of intensity level associated with the selected feature set; and
selecting, by the content object computer, a content object for playback on the user device, based on the determined value of intensity level.

15. The method of claim 14, further comprising the steps of:
identifying, by the content object computer, an intensity level range for the selected feature set;
determining, by the content object computer, a user biometric compatible with the user device;
computing, by the content object computer, a plurality of threshold for the intensity level range values, the intensity level range values comprising a high intensity threshold, a low-mid intensity threshold, and high-mid intensity threshold for the compatible user biometric; and
providing, by the content object computer, a content object for playback on the user device from the ordered list of second plurality of content objects, based on a comparison of the collected biometric data with the plurality of threshold values.

16. The method of claim 13, further comprising the steps of:
upon a list of a pre-generated list of content objects not being stored in the memory of the user device, selecting a content object from the master lookup dataset for playback on the user device.

17. The method of claim 11, further comprising the steps of:
receiving, by the content object computer, a feature set selection from the user device;
identifying, by the content object computer, an intensity level range for the selected feature set;
for each intensity level in the intensity level range, selecting, by the content object computer, one or more content objects from the ordered list of second plurality of content objects;
randomizing, by the content object computer, an order of the selected one or more content objects;
creating, by the content object computer, an ordered list of the selected one or more content objects; and
associating, by the content object computer, the ordered list of the selected one or more content objects with the selected feature set.

18. The method of claim 11, further comprising the steps of:
starting, by the content object computer, playback of a content object, from the ordered list of the second plurality of content objects, on the user device;
receiving, by the content object computer, biometric data from the user device;
determining, by the content object computer, whether historic data stored for the user device contains more than one content object for a given period of time;
in response to a determination that the historic data for the user device contains more than one content object for a particular period of time, comparing, by the content object computer, the biometric data received from user device to threshold data for the particular period of time; and
switching, by the content object computer, the playback to another content object from the ordered list of the second plurality of content objects on the user device, the another content object based on the comparison.

19. The method of claim 11, further comprising the steps of:
upon a user device action being received by the content object computer, identifying the type of user device action; and
modifying, by the content object computer, the playback based on the identified type of user device action.

20. The method of claim 19, further comprising the steps of:
terminating, by the content object computer, playback of a content object currently played on the user device and record statistical data associated with the user device; and
sending, by the content object computer, the statistical data for display on the user device;
wherein the identified type of user device action is a termination request.
